(19) United States
(12) Patent Application Publication
(10) Pub. No.: US 2020/0321006 A1
(43) Pub. Date: Oct. 8, 2020

(54) AGENT APPARATUS, AGENT APPARATUS CONTROL METHOD, AND STORAGE MEDIUM

(71) Applicant: HONDA MOTOR CO., LTD., Tokyo (JP)

(72) Inventors: Hiroshi Honda, Wako-shi (JP); Masaki Kurihara, Wako-shi (JP)

(21) Appl. No.: 16/820,798

(22) Filed: Mar. 17, 2020

(30) Foreign Application Priority Data
Mar. 19, 2019 (JP) 2019-051198

(51) Int. Cl. G10L 15/26; G10L 15/32; G10L 15/22; B60W 50/10

(52) U.S. Cl. CPC G10L 15/265; G10L 15/32; B60W 2540/21; B60W 50/10; G10L 15/22

(57) ABSTRACT

An agent apparatus according to embodiments includes: a plurality of agent functions each including a recognizer configured to recognize speech according to an utterance of an occupant of a vehicle and configured to provide a service including a response on the basis of a speech recognition result obtained by the recognizer; and a storage controller configured to cause a storage to store the speech of the utterance of the occupant, wherein a first agent function selected by the occupant from the plurality of agent functions outputs speech stored in the storage and the speech recognition result recognized by the recognizer included in the first agent function to another agent function.

### CROSS-REFERENCE TO RELATED APPLICATION

Priority is claimed on Japanese Patent Application No. 2019-051198, filed Mar. 19, 2019, the content of which is incorporated herein by reference.

### BACKGROUND

### Field of the Invention

The present invention related to an agent apparatus, an agent apparatus control method, and a storage medium.

### Description of Related Art

A conventional technology related to an agent function of providing information about driving assistance, vehicle control, other applications, and the like at the request of an occupant of a vehicle while conversing with the occupant has been disclosed (Japanese Unexamined Patent Application, First Publication No. 2006-335231).

### SUMMARY

Although a technology of mounting agent functions in a vehicle has been put to practical use in recent years, an occupant needs to call a single agent and transmit a request thereto even when a plurality of agents are used. Accordingly, there are cases in which the occupant cannot call an agent most suitable to execute processing with respect to the request when the occupant has not ascertained features of each agent and thus cannot obtain appropriate results.

An object of aspects of the present invention devised in view of such circumstances is to provide an agent apparatus, an agent apparatus control method, and a storage medium which can provide more appropriate response results.

An agent apparatus, an agent apparatus control method, and a storage medium according to the present invention employ the following configurations.

(1): An agent apparatus according to an aspect of the present invention is an agent apparatus including: a plurality of agent functions each including a recognizer configured to recognize speech according to an utterance of an occupant of a vehicle and configured to provide a service including a response on the basis of a speech recognition result obtained by the recognizer; and a storage controller configured to cause a storage to store the speech of the utterance of the occupant, wherein a first agent function selected by the occupant from the plurality of agent functions outputs speech stored in the storage and the speech recognition result recognized by the recognizer included in the first agent function to another agent function.

(2): In the aspect of (1), the first agent function outputs the speech stored in the storage and the speech recognition result to another agent function at a timing at which the speech recognition result with respect to the utterance of the occupant is acquired by the recognizer.

(3): In the aspect of (1), the agent apparatus further includes an output controller configure to cause an output to output a response result with respect to the utterance of the occupant, wherein, when a certainty factor of a response result acquired by the first agent function is less than a threshold value, the output controller changes the response result provided to the occupant to a response result acquired by the other agent function and causes the output to output the changed response result.

(4): In the aspect of (1), the other agent function generates a response result with respect to details of a request of the occupant on the basis of a response result of the first agent function.

(5): In the aspect of (1), the first agent function selects one or more other agent functions from the plurality of agent functions on the basis of the speech recognition result obtained by the recognizer and outputs the speech stored in the storage and the speech recognition result to the selected other agent functions.

(6): An agent apparatus control method according to another aspect of the present invention is an agent apparatus control method, using a computer, including: activating a plurality of agent functions each including a recognizer configured to recognize speech according to an utterance of an occupant of a vehicle; providing a service including a response on the basis of a speech recognition result obtained by the recognizer as functions of the activated agent functions; causing a storage to store the speech of the utterance of the occupant; and, by a first agent function selected by the occupant from the plurality of agent functions, outputting speech stored in the storage and the speech recognition result recognized by the recognizer included in the first agent function to another agent function.

(7): A storage medium according to another aspect of the present invention is a computer-readable non-transitory storage medium storing a program causing a computer to: activate a plurality of agent functions each including a recognizer configured to recognize speech according to an utterance of an occupant of a vehicle; provide a service including a response on the basis of a speech recognition result obtained by of the recognizer as functions of the activated agent functions; cause a storage to store the speech of the utterance of the occupant; and, by a first agent function selected by the occupant from the plurality of agent functions, output speech stored in the storage and the speech recognition result recognized by the recognizer included in the first agent function to another agent function.

According to the aspects of (1) to (7), it is possible to provide more appropriate response results.

### BRIEF DESCRIPTION OF THE DRAWINGS

FIG. 1 is a configuration diagram of an agent system including an agent apparatus.

FIG. 2 is a diagram showing a configuration of an agent apparatus according to an embodiment and apparatuses mounted in a vehicle M.

FIG. 3 is a diagram showing an arrangement example of a display/operating device and a speaker unit.

FIG. 4 is a diagram showing parts of a configuration of an agent server and the configuration of the agent apparatus.

FIG. 5 is a diagram showing an example of an image displayed by a display controller in a situation before an occupant speaks.

FIG. 6 is a diagram showing an example of an image displayed by the display controller in a situation in which a first agent function is activated.

FIG. 7 is a diagram showing an example of a state in which a response result is output.

FIG. 8 is a diagram for describing a state in which a response result obtained by another agent function is output.

FIG. 9 is a diagram for describing a state in which another agent function responds to an occupant.

FIG. 10 is a flowchart showing an example of a processing flow executed by the agent apparatus.

FIG. 11 is a flowchart showing an example of a processing flow executed by an agent apparatus in a modified example.

### DESCRIPTION OF EMBODIMENTS

Hereinafter, embodiments of an agent apparatus, an agent apparatus control method, and a storage medium of the present invention will be described with reference to the drawings. An agent apparatus is an apparatus for realizing a part or all of an agent system. As an example of the agent apparatus, an agent apparatus which is mounted in a vehicle (hereinafter, a vehicle M) and includes a plurality of types of agent functions will be described below. An agent function is, for example, a function of providing various types of information based on a request (command) included in an utterance of an occupant of the vehicle M or mediating network services while conversing with the occupant. Agent functions may include a function of performing control of an apparatus in a vehicle (e.g., an apparatus with respect to driving control or vehicle body control), and the like.

An agent function is realized, for example, using a natural language processing function (a function of understanding the structure and meaning of text), a conversation management function, a network search function of searching for other apparatuses through a network or searching for a predetermined database of a host apparatus, and the like in addition to a speech recognition function of recognizing speech of an occupant (a function of converting speech into text) in an integrated manner. Some or all of such functions may be realized by artificial intelligence (AI) technology. A part of a configuration for executing these functions (particularly, the speech recognition function and the natural language processing and interpretation function) may be mounted in an agent server (external device) which can communicate with an on-board communication device of the vehicle M or a general-purpose communication device included in the vehicle M. The following description is based on the assumption that a part of the configuration is mounted in the agent server and the agent apparatus and the agent server realize an agent system in cooperation. A service providing entity (service/entity) caused to virtually appear by the agent apparatus and the agent serve in cooperation is referred to as an agent.

<Overall Configuration>

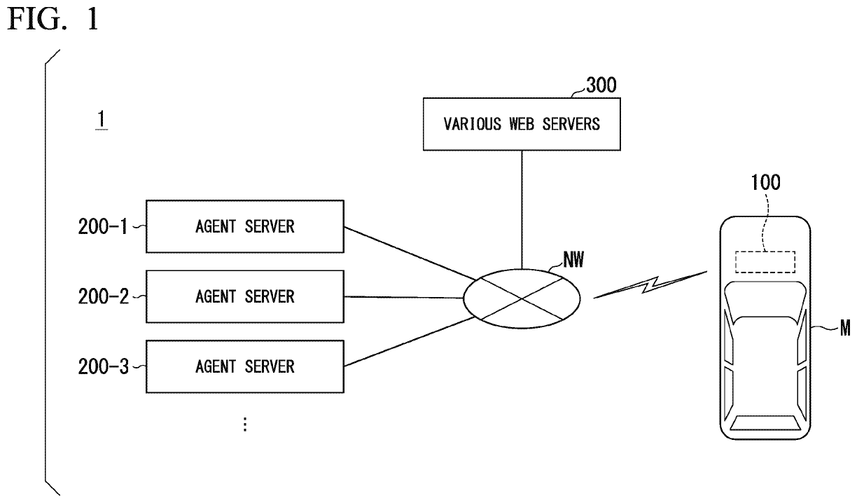

FIG. 1 is a configuration diagram of an agent system 1 including an agent apparatus 100. The agent system 1 includes, for example, the agent apparatus 100 and a plurality of agent servers 200-1, 200-2, 200-3, . . . . Numerals following the hyphens at the ends of reference numerals are identifiers for distinguishing agents. When agent servers are not distinguished, the agent servers may be simply referred to as an agent server 200. Although three agent servers 200 are shown in FIG. 1, the number of agent servers 200 may be two, four or more. The agent servers 200 are managed by different agent system providers, for example. Accordingly, agents in the present embodiment are agents realized by different providers. For example, automobile manufacturers, network service providers, electronic commerce subscribers, cellular phone vendors, and the like may be conceived as providers, and any entity (a corporation, an organization, an individual, or the like) may become an agent system provider.

The agent apparatus 100 communicates with the server device 200 via a network NW. The network NW includes, for example, some or all of the Internet, a cellular network, a Wi-Fi network, a wide area network (WAN), a local area network (LAN), a public line, a telephone line, a wireless base station, and the like. Various web servers 300 are connected to the network NW, and the agent server 200 or the agent apparatus 100 can acquire web pages and various types of information via a web application programming interface (API) from the various web servers 300 through the network NW via.

The agent apparatus 100 makes a conversation with an occupant of the vehicle M, transmits speech from the occupant to the agent server 200 and presents a response acquired from the agent server 200 to the occupant in the form of speech output or image display. The agent apparatus 100 performs control with respect to a vehicle apparatus 50, and the like on the basis of a request from the occupant.

### First Embodiment

### [Vehicle]

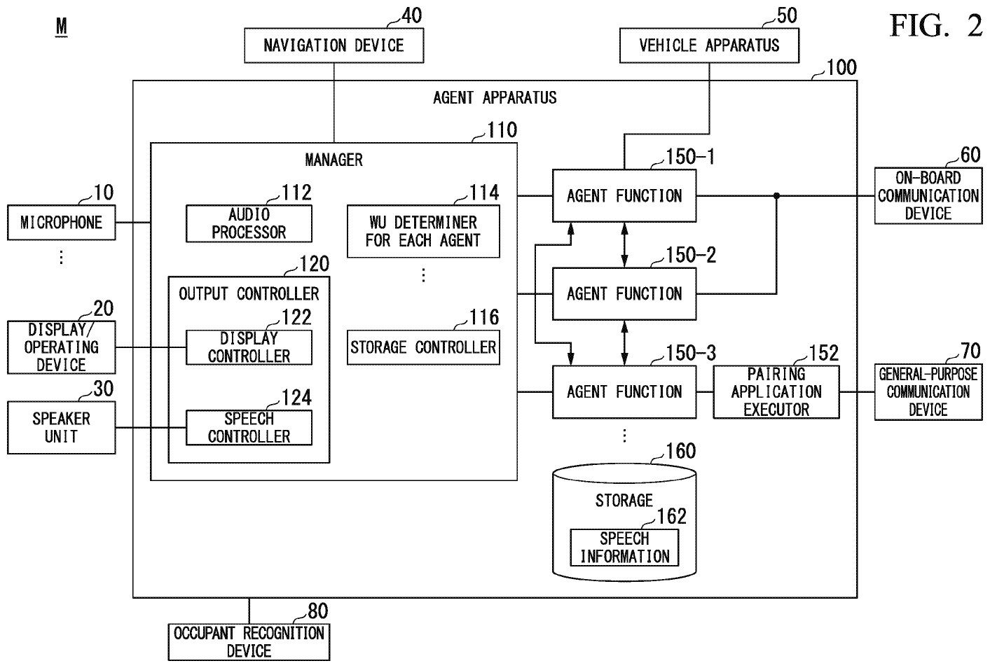

FIG. 2 is a diagram showing a configuration of the agent apparatus 100 according to an embodiment and apparatuses mounted in the vehicle M. For example, one or more microphones 10, a display/operating device 20, a speaker unit 30, a navigation device 40, the vehicle apparatus 50, an on-board communication device 60, an occupant recognition device 80, and the agent apparatus 100 are mounted in the vehicle M. There are cases in which a general-purpose communication device 70 such as a smartphone is included in a vehicle cabin and used as a communication device. Such devices are connected to each other through a multiplex communication line such as a controller area network (CAN) communication line, a serial communication line, a wireless communication network, or the like. The components shown in FIG. 2 are merely an example and some of the components may be omitted or other components may be further added. A combination of the display/operating device 20 and the speaker unit 30 is an example of an “output.”

The microphone 10 is an audio collector for collecting sound generated in the vehicle cabin. The display/operating device 20 is a device (or a group of devices) which can display images and receive an input operation. The display/operating device 20 includes, for example, a display device configured as a touch panel. Further, the display/operating device 20 may include a head up display (HUD) or a mechanical input device. The speaker unit 30 includes, for example, a plurality of speakers (sound output) provided at different positions in the vehicle cabin. The display/operating device 20 and the speaker unit 30 may be shared by the agent apparatus 100 and the navigation device 40. This will be described in detail later.

The navigation device 40 includes a positioning device such as a navigation human machine interface (HMI) or a global positioning system (GPS), a storage device which stores map information, and a control device (navigation controller) which performs route search and the like. Some or all of the microphone 10, the display/operating device 20, and the speaker unit 30 may be used as a navigation HMI.

The navigation device 40 searches for a route (navigation route) for moving to a destination input by an occupant from a position of the vehicle M identified by the positioning device and outputs guide information using the navigation HMI such that the vehicle M can travel along the route. The route search function may be included in a navigation server accessible through the network NW. In this case, the navigation device 40 acquires a route from the navigation server and outputs guide information. The agent apparatus 100 may be constructed on the basis of the navigation controller. In this case, the navigation controller and the agent apparatus 100 are integrated in hardware.

The vehicle apparatus 50 includes, for example, a driving power output device such as an engine and a motor for traveling, an engine starting motor, a door lock device, a door opening/closing device, an air-conditioning device, and the like.

The on-board communication device 60 is, for example, a wireless communication device which can access the network NW using a cellular network or a Wi-Fi network.

The occupant recognition device 80 includes, for example, a seating sensor, an in-vehicle camera, an image recognition device, and the like. The seating sensor includes a pressure sensor provided under a seat, a tension sensor attached to a seat belt, and the like. The in-vehicle camera is a charge coupled device (CCD) camera or a complementary metal oxide semiconductor (CMOS) camera provided in a vehicle cabin. The image recognition device analyzes an image of the in-vehicle camera and recognizes presence or absence, a face orientation, and the like of an occupant for each seat.

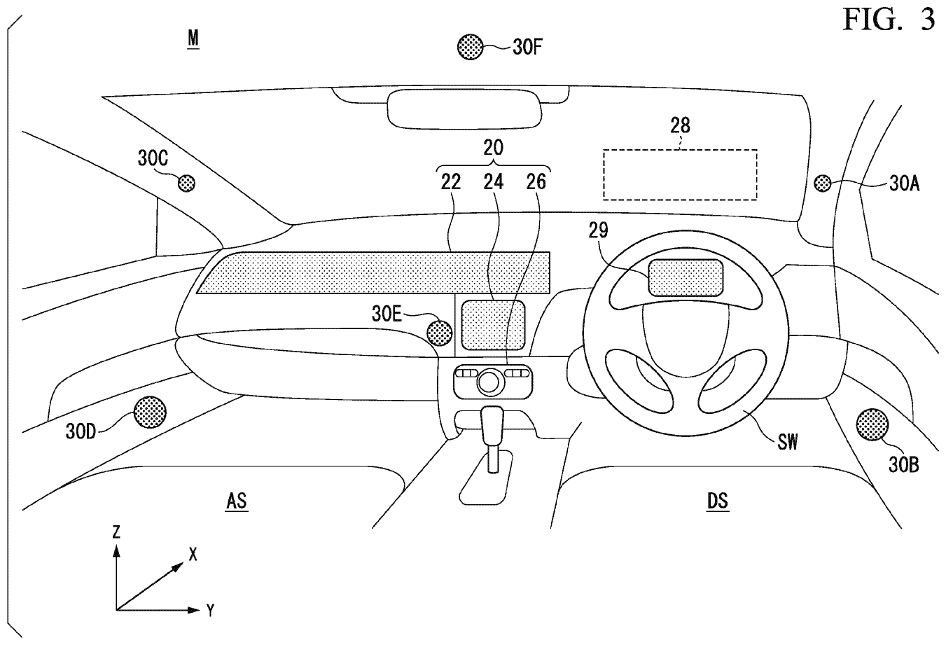

FIG. 3 is a diagram showing an arrangement example of the display/operating device 20 and the speaker unit 30. The display/operating device 20 includes, for example, a first display 22, a second display 24, and an operating switch ASSY 26. The display/operating device 20 may further include an HUD 28. The display/operating device 20 may further include a meter display 29 provided at a part of an instrument panel which faces a driver's seat DS. A combination of the first display 22, the second display 24, HUD 28, and the meter display 29 is an example of a “display.”

The vehicle M includes, for example, the driver's seat DS in which a steering wheel SW is provided, and a passenger seat AS provided in a vehicle width direction (Y direction in the figure) with respect to the driver's seat DS. The first display 22 is a laterally elongated display device extending from the vicinity of the middle region of the instrument panel between the driver's seat DS and the passenger seat AS to a position facing the left end of the passenger seat AS.

The second display 24 is provided in the vicinity of the middle region between the driver's seat DS and the passenger seat AS in the vehicle width direction under the first display. For example, both the first display 22 and the second display 24 are configured as touch panels and include a liquid crystal display (LCD), an organic electroluminescence (organic EL) display, a plasma display, or the like as a display. The operating switch ASSY 26 is an assembly of dial switches, button type switches, and the like. The HUD 28 is, for example, a device that causes an image overlaid on a landscape to be viewed and allows an occupant to view a virtual image by projecting light including an image to, for example, a front windshield or a combiner of the vehicle M. The meter display 29 is, for example, an LCD, an organic EL, or the like and displays meters such as a speedometer and a tachometer. The display/operating device 20 outputs details of an operation performed by an occupant to the agent apparatus 100. Details displayed by each of the above-described displays may be determined by the agent apparatus 100.

The speaker unit 30 includes, for example, speakers 30A to 30F. The speaker 30A is provided on a window pillar (so-called A pillar) on the side of the driver's seat DS. The speaker 30B is provided on the lower part of the door near the driver's seat DS. The speaker 30C is provided on a window pillar on the side of the passenger seat AS. The speaker 30D is provided on the lower part of the door near the passenger seat AS. The speaker 30E is provided in the vicinity of the second display 24. The speaker 30F is provided on the ceiling (roof) of the vehicle cabin. The speaker unit 30 may be provided on the lower parts of the doors near a right rear seat and a left rear seat.

In such an arrangement, a sound image is located near the driver's seat DS, for example, when only the speakers 30A and 30B are caused to output sound. “Locating a sound image” is, for example, to determine a spatial position of a sound source perceived by an occupant by controlling the magnitude of sound transmitted to the left and right ears of the occupant. When only the speakers 30C and 30D are caused to output sound, a sound image is located near the passenger seat AS. When only the speaker 30E is caused to output sound, a sound image is located near the front part of the vehicle cabin. When only the speaker 30F is caused to output sound, a sound image is located near the upper part of the vehicle cabin. The present invention is not limited thereto and the speaker unit 30 can locate a sound image at any position in the vehicle cabin by controlling distribution of sound output from each speaker using a mixer and an amplifier.

### [Agent Apparatus]

Referring back to FIG. 2, the agent apparatus 100 includes a manager 110, agent functions 150-1, 150-2 and 150-3, a pairing application executer 152, and a storage 160. The manager 110 includes, for example, an audio processor 112, a wake-up (WU) determiner 114 for each agent, a storage controller 116, an output controller 120. When the agent functions are not distinguished, they are simply referred to as an agent function 150. Illustration of three agent functions 150 is merely an example in which they correspond to the number of the agent servers 200 in FIG. 1 and the number of agent functions 150 may be two, four or more. A software arrangement in FIG. 2 is shown in a simplified manner for description and can be arbitrarily modified, for example, such that the manager 110 may be interposed between the agent function 150 and the on-board communication device 60 in practice.

Each component of the agent apparatus 100 is realized, for example, by a hardware processor such as a central processing unit (CPU) executing a program (software). Some or all of these components may be realized by hardware (a circuit including circuitry) such as a large scale integration (LSI) circuit, an application specific integrated circuit (ASIC), a field-programmable gate array (FPGA) or a graphics processing unit (GPU) or realized by software and hardware in cooperation. The program may be stored in advance in a storage device (storage device including a non-transitory storage medium) such as a hard disk drive (HDD) or a flash memory or stored in a separable storage medium (non-transitory storage medium) such as a DVD or a CD-ROM and installed when the storage medium is inserted into a drive device.

The storage 160 is realized by the aforementioned various storage devices. The storage 160 stores, for example, data such as speech information 162 and programs. The speech information 162 includes, for example, one or both of speech (raw speech data) of utterances of an occupant acquired through the microphone 10 and speech (voice stream) on which audio processing has been performed by the audio processor 112.

The manager 110 functions according to execution of an operating system (OS) or a program such as middleware.

The audio processor 112 of the manager 110 receives collected sound from the microphone 10 and performs audio processing on the received sound such that the sound becomes a state in which it is suitable to recognize a wake-up word preset for each agent. Audio processing is, for example, noise removal through filtering using a bandpass filter or the like, amplification of sound, and the like.

The WU determiner 114 for each agent is present corresponding to each of the agent functions 150-1, 150-2 and 150-3 and recognizes a wake-up word predetermined for each agent. The WU determiner 114 for each agent recognizes, from speech on which audio processing has been performed (voice stream), whether the speech is a wake-up word. First, the WU determiner 114 for each agent detects a speech section on the basis of amplitudes and zero crossing of speech waveforms in the voice stream. The WU determiner 114 for each agent may perform section detection based on speech recognition and non-speech recognition in units of frames based on Gaussian mixture model (GMM).

Subsequently, the WU determiner 114 for each agent converts the speech in the detected speech section into text to obtain text information. Then, the WU determiner 114 for each agent determines whether the text information corresponds to a wake-up word. When it is determined that the text information corresponds to a wake-up word, the WU determiner 114 for each agent activates a corresponding agent function 150. The function corresponding to the WU determiner 114 for each agent may be mounted in the agent server 200. In this case, the manager 110 transmits the voice stream on which audio processing has been performed by the audio processor 112 to the agent server 200, and when the agent server 200 determines that the voice stream is a wake-up word, the agent function 150 is activated according to an instruction from the agent server 200. Each agent function 150 may be constantly activated and perform determination of a wake-up word by itself. In this case, the manager 110 need not include the WU determiner 114 for each agent.

The storage controller 116 controls information stored in the storage 160. For example, when some of the plurality of agent functions 150 respond to an utterance of an occupant, the storage controller 116 causes the storage 160 to store speech input from the microphone 10 and speech processed by the audio processor 112 as the speech information 162. The storage controller 116 may perform control of deleting the speech information 162 from the storage 160 when a predetermined time has elapsed from storage of the speech information 162 or a response to a request of the occupant included in the speech information 162 is completed.

The output controller 120 provides a service and the like to the occupant by causing the display or the speaker unit 30 to output information such as a response result according to an instruction from the manager 110 or the agent function 150. The output controller 120 includes, for example, a display controller 122 and a speech controller 124.

The display controller 122 causes the display to display an image in at least a part of the area thereof according to an instruction from the output controller 120. It is assumed that an image with respect to an agent is displayed by the first display 22 in the following description. The display controller 122 generates, for example, an image of a personified agent (hereinafter referred to as an agent image) that communicates with an occupant in the vehicle cabin and causes the first display 22 to display the generated agent image according to control of the output controller 120. The agent image is, for example, an image in the form of speaking to the occupant. The agent image may include, for example, a face image from which at least an observer (occupant) can recognize an expression or a face orientation. For example, the agent image may display parts imitating eyes and a nose at the center of the face region such that an expression or a face orientation is recognized on the basis of the positions of the parts at the center of the face region. The agent image may be three-dimensionally perceived such that the face orientation of the agent is recognized by the observer by including a head image in the three-dimensional space or may include an image of a main body (body, hands and legs) such that an action, a behavior, a posture, and the like of the agent are recognized. The agent image may be an animation image. For example, the display controller 122 may cause an agent image to be displayed in a display area near a position of the occupant recognized by the occupant recognition device 80 or generate an agent image having a face facing the position of the occupant and cause the agent image to be displayed.

The speech controller 124 causes some or all speakers included in the speaker unit 30 to output speech according to an instruction from the output controller 120. The speech controller 124 may perform control of locating a sound image of agent speech at a position corresponding to a display position of an agent image using a plurality of speaker units 30. The position corresponding to the display position of the agent image is, for example, a position predicted to be perceived by the occupant as a position at which the agent image is talking in the agent speech, and specifically, is a position near the display position of the agent image (for example, within 2 to 3 [cm]).

The agent function 150 causes an agent to appear in cooperation with the agent server 200 corresponding thereto to provide a service including a causing an output to output a response using speech in response to an utterance of the occupant of the vehicle. The agent function 150 may include one authorized to control the vehicle apparatus 50. The agent function 150 may include one that cooperates with the general-purpose communication device 70 via the pairing application executer 152 and communicates with the agent server 200.

For example, the agent function 150-1 is authorized to control the vehicle apparatus 50. The agent function 150-1 communicates with the agent server 200-1 via the on-board communication device 60. The agent function 150-2 communicates with the agent server 200-2 via the on-board communication device 60. The agent function 150-3 cooperates with the general-purpose communication device 70 via the pairing application executer 152 and communicates with the agent server 200-3.

The pairing application executer 152 performs pairing with the general-purpose communication device 70 according to Bluetooth (registered trademark), for example, and connects the agent function 150-3 to the general-purpose communication device 70. The agent function 150-3 may be connected to the general-purpose communication device 70 according to wired communication using a universal serial bus (USB) or the like.

There are cases below in which an agent that is caused to appear by the agent function 150-1 and the agent server 200-1 in cooperation is referred to as “agent 1,” an agent that is caused to appear by the agent function 150-2 and the agent server 200-2 in cooperation is referred to as “agent 2,” and an agent that is caused to appear by the agent function 150-3 and the agent server 200-3 in cooperation is referred to as “agent 3.” The agent functions 150-1 to 150-3 execute processing on an utterance (speech) of the occupant input from the microphone 10, the audio processor 112, and the like and output execution results (for example, results of responses to a request included in the utterance) to the manager 110.

The agent functions 150-1 to 150-3 transfer speech, speech recognition results input from the microphone 10, response results, and the like to other agent functions and cause other agent functions to execute processing. This function will be described in detail later.

### [Agent Server]

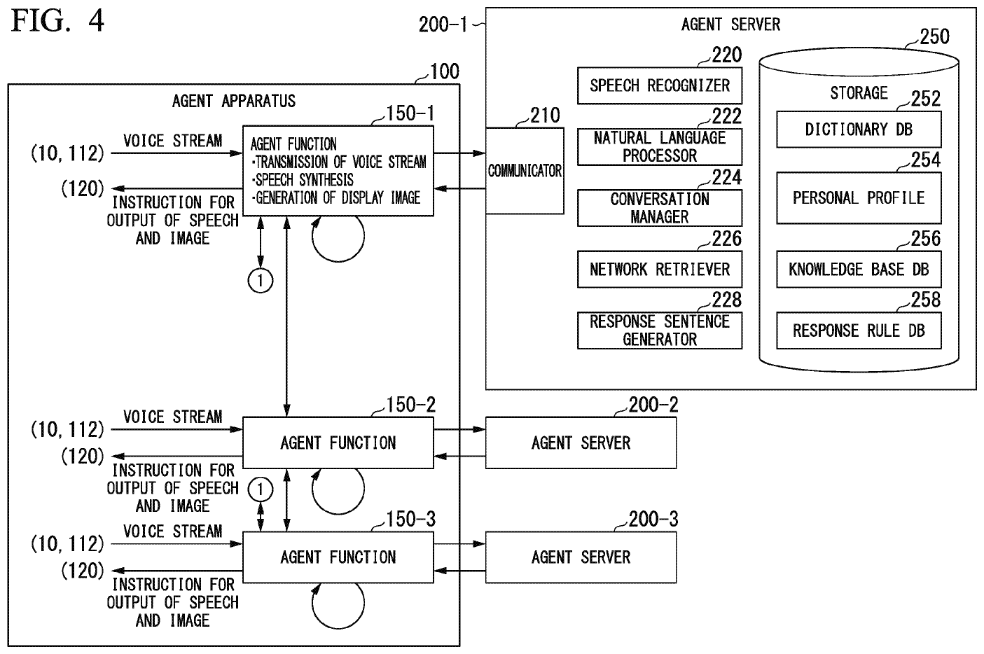

FIG. 4 is a diagram showing parts of the configuration of the agent server 200 and the configuration of the agent apparatus 100. Hereinafter, the configuration of the agent server 200 and operations of the agent function 150, and the like will be described. Here, description of physical communication from the agent apparatus 100 to the network NW will be omitted. Although the agent function 150-1 and the agent server 200-1 will be mainly described below, almost the same operations are performed with respect to other sets of agent functions and agent servers even though there are differences between detailed functions, databases, and the like thereof.

The agent server 200-1 includes a communicator 210. The communicator 210 is, for example, a network interface such as a network interface card (NIC). Further, the agent server 200-1 includes, for example, a speech recognizer 220, a natural language processor 222, a conversation manager 224, a network retriever 226, a response sentence generator 228, and a storage 250. These components are realized, for example, by a hardware processor such as a CPU executing a program (software). Some or all of these components may be realized by hardware (a circuit including circuitry) such as an LSI circuit, an ASIC, an FPGA or a GPU or realized by software and hardware in cooperation. The program may be stored in advance in a storage device (a storage device including a non-transitory storage medium) such as an HDD or a flash memory or stored in a separable storage medium (a non-transitory storage medium) such as a DVD or a CD-ROM and installed when the storage medium is inserted into a drive device. A combination of the speech recognizer 220 and the natural language processor 222 is an example of a “recognizer.”

The storage 250 is realized by the aforementioned various storage devices. The storage 250 stores, for example, data such as a dictionary database (DB) 252, a personal profile 254, a knowledge base DB 256, and a response rule DB 258 and programs.

In the agent apparatus 100, the agent function 150-1 transmits a voice stream or a voice stream on which processing such as compression or encoding has been performed, acquired from the microphone 10, the audio processor 112, or the like to the agent server 200-1. When a command (request details) which can cause local processing (processing performed without the agent server 200-1) to be performed is recognized, the agent function 150-1 may perform processing requested through the command.

The command which can cause local processing to be performed is, for example, a command to which a reply can be given by referring to the storage 160 included in the agent apparatus 100. For specifically, the command which can cause local processing to be performed is, for example, a command for retrieving the name of a specific person from telephone directory data present in the storage 160 and calling a telephone number associated with the matching name (calling a counterpart). Accordingly, the agent function 150 may include some functions included in the agent server 200-1.

When the voice stream is acquired, the speech recognizer 220 performs speech recognition and outputs text information and the natural language processor 222 performs semantic interpretation on the text information with reference to the dictionary DB 252. The dictionary DB 252 is, for example, a DB in which abstracted semantic information is associated with text information. The dictionary DB 252 may include information about lists of synonyms. Steps of processing of the speech recognizer 220 and steps of processing of the natural language processor 222 are not clearly separated from each other and may affect each other in such a manner that the speech recognizer 220 receives a processing result of the natural language processor 222 and corrects a recognition result.

When text such as “Today's weather” or “How is the weather today?” is recognized as a speech recognition result, for example, the natural language processor 222 generates an internal state in which a user intention has been replaced with “Weather: today.” Accordingly, even when request speech includes variations in text and differences in wording, it is possible to easily make a conversation suitable for the request. The natural language processor 222 may recognize the meaning of text information using artificial intelligence processing such as machine learning processing using probabilities and generate a command based on a recognition result, for example.

The conversation manager 224 determines details of a response (for example, details of an utterance for the occupant and an image to be output) for the occupant of the vehicle M with reference to the personal profile 254, the knowledge base DB 256 and the response rule DB 258 on the basis of an input command. The personal profile 254 includes personal information, preferences, past conversation histories, and the like of occupants stored for each occupant. The knowledge base DB 256 is information defining relationships between objects. The response rule DB 258 is information defining operations (replies, details of apparatus control, or the like) that need to be performed by agents for commands.

The conversation manager 224 may identify an occupant by collating the personal profile 254 with feature information acquired from a voice stream. In this case, personal information is associated with the speech feature information in the personal profile 254, for example. The speech feature information is, for example, information about features of a talking manner such as a voice pitch, intonation and rhythm (tone pattern), and feature quantities according to mel frequency cepstrum coefficients and the like. The speech feature information is, for example, information obtained by allowing the occupant to utter a predetermined word, sentence, or the like when the occupant is initially registered and recognizing the speech.

The conversation manager 224 causes the network retriever 226 to perform retrieval when the command is to request information that can be retrieved through the network NW. The network retriever 226 access the various web servers 300 via the network NW and acquires desired information. “Information that can be retrieved through the network NW” may be evaluation results of general users of a restaurant near the vehicle M or a weather forecast corresponding to the position of the vehicle M on that day, for example.

The response sentence generator 228 generates a response sentence and transmits the generated response sentence (response result) to the agent apparatus 100 such that details of the utterance determined by the conversation manager 224 are delivered to the occupant of the vehicle M. The response sentence generator 228 may acquire a recognition result of the occupant recognition device 80 from the agent apparatus 100, and when the occupant who has made the utterance including the command is identified as an occupant registered in the personal profile 254 through the acquired recognition result, generate a response sentence for calling the name of the occupant or speaking in a manner similar to the speaking manner of the occupant.

When the agent function 150 acquires the response sentence, the agent function 150 instructs the speech controller 124 to perform speech synthesis and output speech. The agent function 150 instructs the display controller 122 to display an agent image suited to the speech output. In this manner, an agent function in which an agent that has virtually appeared replies to the occupant of the vehicle M is realized.

### [Functions of Agent Function]

Hereinafter, functions of agent function 150 will be described in detail. In the following, functions of the agent function 150 and response results output from the output controller 120 according to functions of the agent function 150 and provided to an occupant (hereinafter referred to as an occupant P) will be mainly described. In the following, an agent function selected by the occupant P will be referred to as a “first agent function.” “Selecting by the occupant P” is, for example, activating (or calling) using a wake-up word included in an utterance of the occupant P, an agent activation switch, or the like.

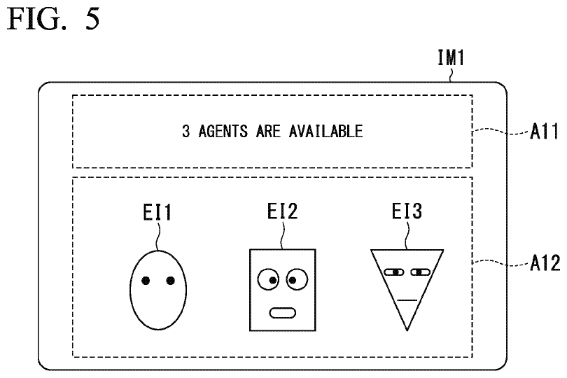

FIG. 5 is a diagram showing an example of an image IM1 displayed by the display controller 122 in a situation before the occupant P speaks. Details displayed in the image IM1, a layout, and the like are not limited thereto. The image IM1 is generated by the display controller 122 on the basis of an instruction from the output controller 120 or the like. The above description is also applied to description of images below.

When the occupant P does not converse with an agent (in a state in which the first agent function is not present), for example, the output controller 120 causes the display controller 122 to generate the image IM1 as an initial state screen and causes the first display 22 to display the generated image IM1.

The image IM1 includes, for example, a text information display area A11 and a response result display area A12. For example, information about the number and types of available agents is displayed in the text information display area A11. Available agents are, for example, agents that can respond to an utterance of the occupant. Available agents are set, for example, on the basis of an area and a time period in which the vehicle M is traveling, situations of agents, and the occupant P recognized by the occupant recognition device 80. Situations of agents include, for example, a situation in which the vehicle M is present underground or in a tunnel and thus cannot communicate with the agent server 200 or a situation in which a process according to another command is being executed in advance and thus a process for the next utterance cannot be executed. In the example of FIG. 5, text information of “3 agents are available” is displayed in the text information display area A11.

Agent images associated with available agents are displayed in the response result display area A12. In the example of FIG. 5, agent images EI1 to EI3 associated with agent functions 150-1 to 150-3 are displayed in the response result display area A12. Accordingly, the occupant P can easily ascertain the number and types of available agents.

Here, the WU determiner 114 for each agent recognizes a wake-up word included in the utterance of the occupant P and activates the first agent function corresponding to the recognized wake-up word (for example, the agent function 150-1). The agent function 150-1 causes the first display 22 to display the agent image EI1 according to control of the display controller 122.

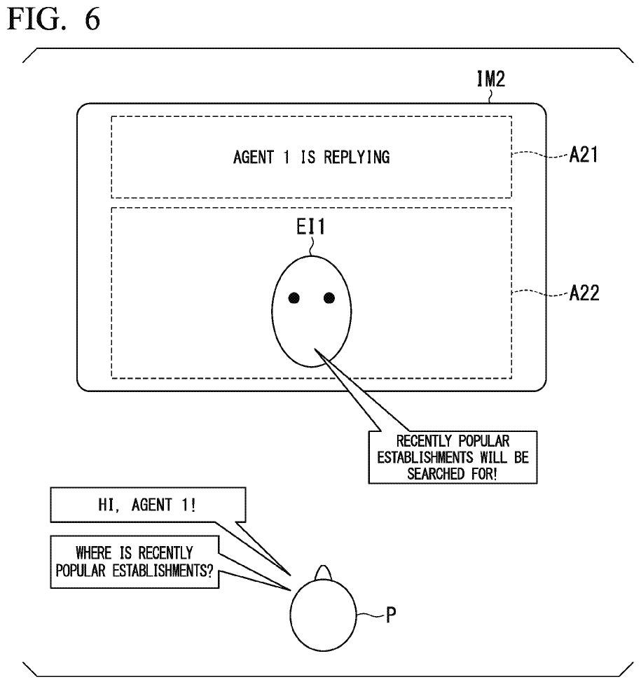

FIG. 6 is a diagram showing an example of an image IM2 displayed by the display controller 122 in a situation in which the first agent function is activated. The image IM2 includes, for example, a text information display area A21 and a response result display area A22. For example, information about an agent conversing with the occupant P is displayed in the text information display area A21. In the example of FIG. 6, text information of “Agent 1 is replying” is displayed in the text information display area A21. In this situation, the text information may not be caused to be displayed in the text information display area A21.

An agent image associated with the agent that is conversing is displayed in the response result display area A22. In the example of FIG. 6, the agent image EI1 associated with agent function 150-1 is displayed in the response result display area A22. Accordingly, the occupant P can easily ascertain that agent 1 is activated.

Next, when the occupant P speaks “Where are recently popular establishments?”, the storage controller 116 causes the storage 160 to store speech or a voice stream input from the microphone 10 or the audio processor 112 as the speech information 162. The agent function 150-1 performs speech recognition based on details of the utterance. Then, when a speech recognition result is acquired, the agent function 150-1 generates a response result (response sentence) based on the speech recognition result and outputs the generated response result to the occupant P to confirm the speech with the occupant P.

In the example of FIG. 6, the speech controller 124 generates speech of “Recently popular establishments will be searched for” in association with the response sentence generated by agent 1 (the agent function 150-1 and the agent server 200-1) and causes the speaker unit 30 to output the generated speech. The speech controller 124 performs sound image locating processing for locating the aforementioned speech of the response sentence near the display position of the agent image EI1 displayed in the response result display area A22. The display controller 122 may generate and display an animation image or the like which is seen by the occupant P such that the agent image EI1 is talking in accordance with the speech output. The display controller 122 may cause the response sentence to be displayed in the response result display area A22. Accordingly, the occupant P can more correctly ascertain whether agent 1 has recognized the details of the utterance.

Next, the agent function 150-1 executes processing based on details of speech recognition and generates a response result. The agent function 150-1 outputs speech information 162 stored in the storage 160 at a point in time when recognition of the speech of the utterance is completed and the speech recognition result to other agent functions (for example, the agent function 150-2 and the agent function 150-3) and causes the other agent functions to execute processing. The speech recognition result output to other agent functions may be, for example, text information converted into text by the speech recognizer 220, a semantic analysis result obtained by the natural language processor 222, a command (request details), or a plurality of combinations thereof.

When other agent functions are not activated when the speech information 162 and the speech recognition result are output, the agent function 150-1 outputs the speech information 162 and the speech recognition result after activation of the other agent functions.

The agent function 150-1 may select information necessary for other agent functions from the speech information 162 and the speech recognition result on the basis of features and functions of a plurality of predetermined other agent functions and output the selected information to the other agent functions.

The agent function 150-1 may output the speech information 162 and the speech recognition result to selected agent functions from the plurality of other agent functions instead of outputting the speech information 162 and the speech recognition result to all the plurality of other agent functions. For example, the agent function 150-1 identifies a function (for example, an establishment search function) necessary for a response using the speech recognition result, selects other agent functions that can realize the identified function and outputs the speech information 162 and the speech recognition result only to the selected other agent functions. Accordingly, it is possible to reduce processing load with respect to agents predicted to be agents which cannot reply or for which appropriate response results cannot be expected.

The agent function 150-1 generates a response result on the basis of the speech recognition result thereof. Other agent functions that have acquired the speech information 162 and the speech recognition result from the agent function 150-1 generate response results on the basis of the acquired information. The agent function 150-1 outputs the information to other agent functions at a timing at which the speech recognition result is obtained, and thus the respective agent functions can execute processing of generating respective response results in parallel. Accordingly, it is possible to obtain response results according to a plurality of agents in a short time. The response results generated by the other agent functions are output to the agent function 150-1, for example.

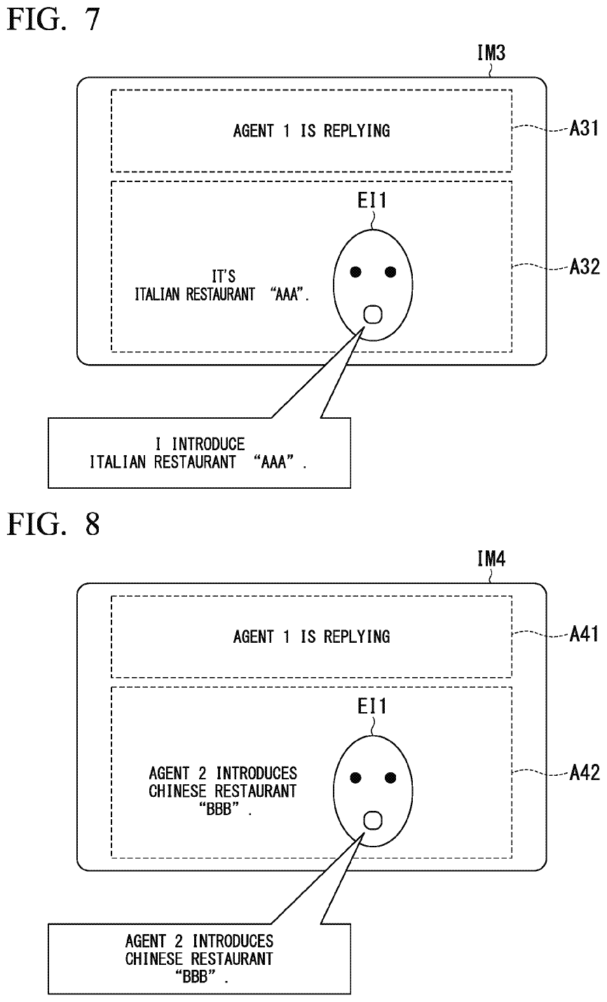

When a response result is acquired through processing of the agent server 200-1 or the like, the agent function 150-1 causes the output controller 120 to output the response result. FIG. 7 is a diagram showing an example of a state in which a response result is output. In the example of FIG. 7, an image IM3 displayed on the first display 22 is represented. The image IM3 includes, for example, a text information display area A31 and a response result display area A32. Information about agent 1 that is conversing is displayed in the text information display area A31 as in the text information display area A21.

For example, an agent image that is conversing and a response result of the agent are displayed in the response result display area A32. In the example of FIG. 7, the agent image EI1 and text information of “It's Italian restaurant AAA” that is a response result of agent 1 are displayed in the response result display area A32. In this situation, the speech controller 124 generates speech of the response result obtained by the agent function 150-1 and performs sound image locating processing for locating the speech near the display position of the agent image EI1. In the example of FIG. 7, the speech controller 124 causes speech of “I'll introduces Italian restaurant AAA” to be output.

When response results from other agent functions are acquired, the agent function 150-1 may perform processing of causing the output controller 120 to output the response results. FIG. 8 is a diagram for describing a state in which a response result acquired from another agent function is output. In the example of FIG. 8, an image IM4 displayed on the first display 22 is represented. The image IM4 includes, for example, a text information display area A41 and a response result display area A42. Information about an agent that is replying is displayed in the text information display area A41 as in the text information display area A31.

For example, an agent image that is replying and a response result of the agent are displayed in the response result display area A42. The display controller 122 acquires, from the agent function 150-1, a response result and identification information of another agent function that has generated the response result and generates an image displayed in the response result display area A42 on the basis of the acquired information.

In the example of FIG. 8, the agent image EI1 and text information of “Agent 2 introduces Chinese restaurant BBB” that is a response result of agent 2 are displayed in the response result display area A42. In this situation, the speech controller 124 generates speech corresponding to the response result and performs sound image locating processing for locating the speech near the display position of the agent image EI1. Accordingly, the occupant can also acquire a response result of another agent as well as a response result of an agent indicated by a wake-up word. When a response result is acquired from the agent function 150-3, the agent function 150-1 causes the output to output the response result of agent 3 as in FIG. 8.

The agent function 150-1 may cause a response result selected from a plurality of response results to be output instead of causing all response results of agent functions to be output, as shown in FIG. 7 and FIG. 8. In this case, the agent function 150-1 selects a response result to be output, for example, on the basis of a certainty factor set for each response result. A certainty factor is, for example, a degree (index value) to which a response result for a request (command) included in an utterance of the occupant P is presumed to be a correct response. The certainty factor is, for example, a degree to which a response to an utterance of the occupant is presumed to be a response matching a request of the occupant or expected by the occupant. Each of the plurality of agent functions 150-1 to 150-3 determines response details on the basis of the personal profile 254, the knowledge base DB 256 and the response rule DB 258 provided in the storage 250 thereof and determines a certainty factor for the response details, for example.

For example, it is assumed that, when a command of “Where are recently popular establishments?” has been received from the occupant P, the conversation manager 224 has acquired information of “clothing shop,” “shoes shop” and “Italian restaurant” from the various web server 300 as information corresponding to the command through the network retriever 226. Here, the conversation manager 224 sets certainty factors of response results having high degrees of matching with the interests of the occupant P to be high with reference to the personal profile 254. For example, when an interest of the occupant P is “dining,” the conversation manager 224 sets a certainty factor of “Italian restaurant” to be higher than those of other information. The conversation manager 224 may set higher certainty factors for higher evaluation results (recommendation degrees) of general users with respect to establishments acquired from the various web server 300.

The conversation manager 224 may determine certainty factors on the basis of the number of response candidates obtained as search results for a command. For example, when the number of response candidates is 1, the conversation manager 224 sets a highest certainty factor because other candidates are not present. The conversation manager 224 sets certainty factors such that, as the number of response candidates increases, certainty factors thereof decrease.

In addition, the conversation manager 224 may determine certainty factors on the basis of fulfillment of response details obtained as search results for a command. For example, when image information as well as text information are acquired as search results, the conversation manager 224 sets high certainty factors because the fulfillment is higher than that in cases in which images cannot be acquired.

The conversation manager 224 may refer to the knowledge base DB 256 using information of a command and response details and set certainty factors on the basis of a relationship therebetween. The conversation manager 224 may refer to the personal profile 254, refer to whether there have been the same questions in a history of recent conversations (for example, within one month), and when there have been the same questions, set certainty factors of response details the same as replies to the questions to be high. The history of conversations may be a history of conversations with the occupant P who has spoken or a history of conversations included in the personal profile 254 other than the occupant P. The conversation manager 224 may combine the above-described plurality of certainty factor setting conditions and set certainty factors.

The conversation manager 224 may perform normalization on certainty factors. For example, the conversation manager 224 may perform normalization such that certainty factors are within a range of 0 to 1 for each of the above-described setting conditions. Accordingly, even in cases in which comparison is performed using certainty factors set according to a plurality of setting conditions, uniform quantification is performed and thus there are no cases in which a certainty factor of only one set of setting conditions is high. As a result, it is possible to select a more appropriate response result on the basis of certainty factors.

For example, it is assumed that the certainty factor of a response result of the agent function 150-1 is 0.2, the certainty factor of a response result of the agent function 150-2 is 0.8, and the certainty factor of a response result of the agent function 150-3 is 0.5. In this case, the agent function 150-1 causes the output to output the response result of agent 2 having the highest certainty factor (that is, the aforementioned image and speech shown in FIG. 8). The agent function 150-1 may cause a response result having a certainty factor equal to or greater than a threshold value to be output.

The agent function 150-1 may cause the output to output a response result acquired from another agent function as a response result obtained by the agent function 150-1 when the certainty factor of a response result of the agent function 150-1 is less than the threshold value. In this case, when the certainty factor of the response result acquired from the other agent function is greater than that of the response result of the agent function 150-1, the agent function 150-1 causes the response result acquired from the other agent function to be output.

The agent function 150-1 may output the response result thereof to another agent function 150 and cause the other agent function to converse with the occupant P after outputting the information shown in FIG. 7. In this case, the other agent function generates a response result for request details of the occupant P on the basis of the response result of the agent function 150-1. For example, the other agent function may generate a response result to which the response result of the agent function 150-1 has been added or a response result different from the response result of the agent function 150-1. “Adding the response result of the agent function 150-1” is using a part or all of the response result of the agent function 150-1, for example.

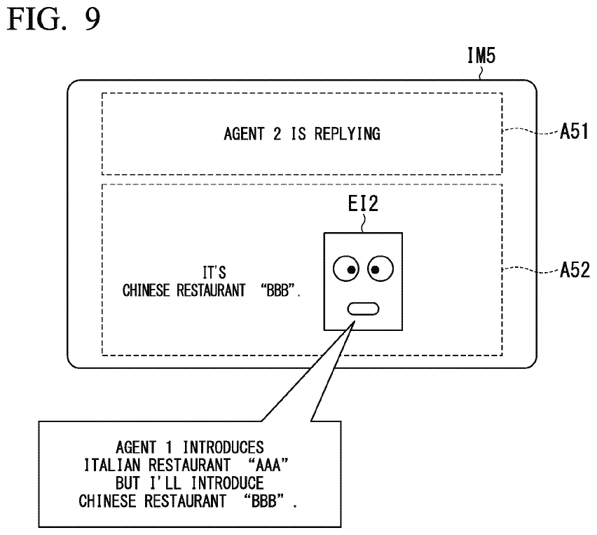

FIG. 9 is a diagram for describing a state in which another agent function responds to an occupant. It is assumed that another agent function is the agent function 150-2 in the following description. In the example of FIG. 9, an image IM5 displayed on the first display 22 is represented. The image IM5 includes, for example, a text information display area A51 and a response result display area A52. Information about agent 2 that is conversing with the occupant P is displayed in the text information display area A51.

For example, an agent image that is conversing and a response result of the agent are displayed in the response result display area A52. In the example of FIG. 9, the agent image EI2 and text information of “It's Chinese restaurant BBB” that is a response result of agent 2 are displayed in the response result display area A52. In this situation, the speech controller 124 generates speech information to which the response result of the agent function 150-1 has been added as speech information of the response result and performs sound image locating processing for locating the speech information near the display position of the agent image EI2. In the example of FIG. 9, speech of “Agent 1 introduces Italian restaurant AAA but I will introduce Chinese restaurant BBB” is output from the speaker unit 30. Accordingly, the occupant P can acquire information from a plurality of agents.

The occupant P need not individually call agents and speak because information is acquired from a plurality of agents, and thus convenience can be improved.

### [Processing Flow]

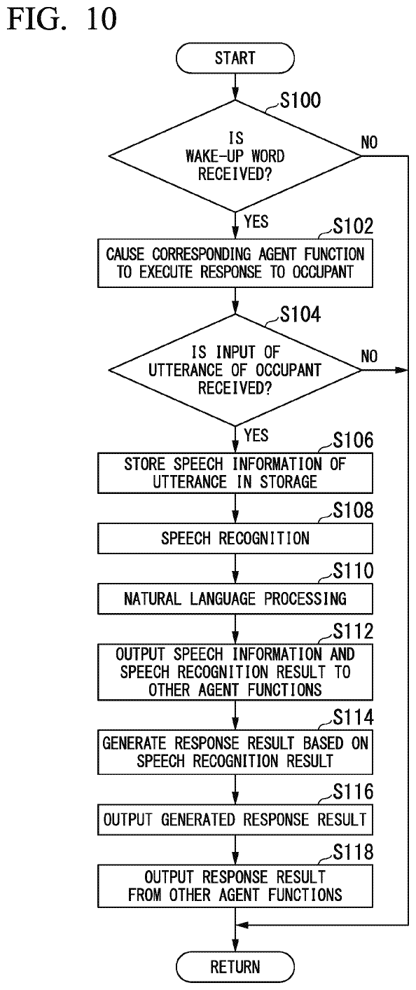

FIG. 10 is a flowchart showing an example of a processing flow executed by the agent apparatus 100. Processing of this flowchart may be repeatedly executed at a predetermined interval or a predetermined timing, for example.

First, the WU determiner 114 for each agent determines whether a wake-up word is received from an utterance of the occupant on which audio processing has been performed by the audio processor 112 (step S100). When it is determined that the wake-up word is received, the WU determiner 114 for each agent cause a corresponding agent function (the first agent function) to respond to the occupant (step S102).

Then, the first agent function determines whether input of an utterance of the occupant is received from the microphone 10 (step S104). When it is determined that the input of the utterance of the occupant is received, the storage controller 116 causes the storage 160 to store speech (speech information 162) of the utterance of the occupant (step S106). Subsequently, the first agent function causes the agent server 200 to execute speech recognition and natural language processing on the speech of the utterance to acquire a speech recognition result (step S108 and step S110). Then, the first agent function outputs the speech information 162 and the speech recognition result to other agent functions (step S112).

Subsequently, the first agent function generates a response result based on the speech recognition result (step S114) and causes the output to output the generated response result (step S116). Then, the first agent function causes the output to output response results from other agent functions (step S118). In the process of step S118, for example, the first agent function may acquire and output response results from other agent functions or cause the response results from other agent functions to be output. Accordingly, processing of this flowchart ends. When it is determined that the wake-up word is not received in the process of step S100 or when it is determined that the input of the utterance of the occupant is not received in the process of step S104, processing of this flowchart ends. When the first agent function has already been activated according to the wake-up word, but input of an utterance has not been received for a predetermined time or longer from activation in the process of step S104, the manager 110 of the agent apparatus 100 may perform processing of ending the first agent function.

### Modified Example

Although the first agent function called by the occupant P outputs, at a timing at which a speech recognition result of an utterance of the occupant P is acquired, speech information and the speech recognition result to other agent functions in the above-described embodiment, the first agent function may output the information at a different timing. For example, the first agent function generates a response result before it outputs the speech information and the speech recognition result to other agent functions and outputs the speech information and the speech recognition result to other agent functions when the certainty factor of the generated response result thereof is less than the threshold value to cause them to execute processing.

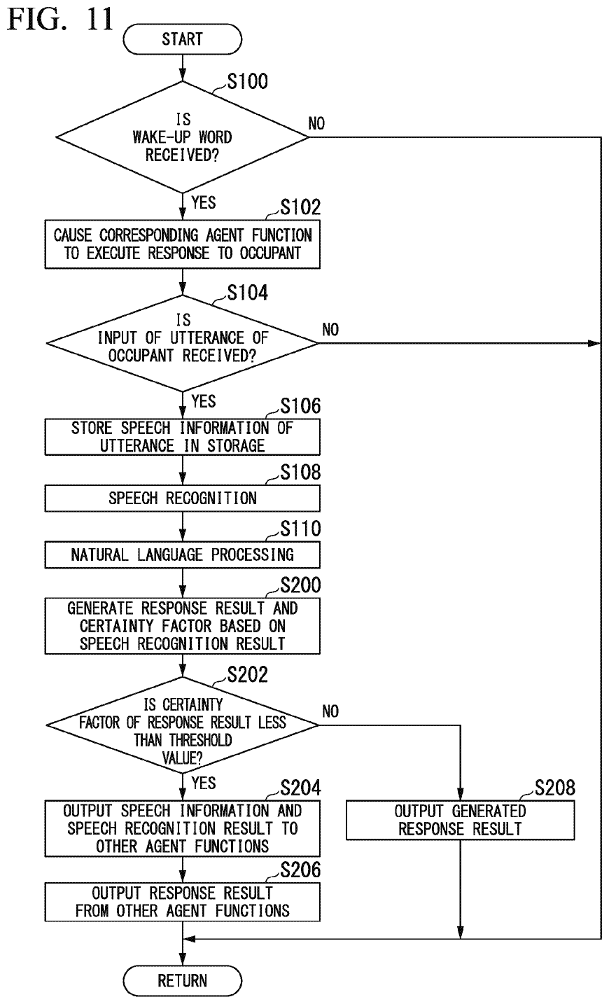

FIG. 11 is a flowchart showing an example of a processing flow executed by the agent apparatus 100 in a modified example. The flowchart shown in FIG. 11 differs from the above-described flowchart of FIG. 10 in that processes of steps S200 to S208 are included instead of the processes of steps S112 to S118. Accordingly, the processes of steps S200 to S208 will be mainly described below.

After acquisition of the speech recognition result in the processes of step S108 and step S110, the first agent function generates a response result and a certainty factor based on the speech recognition result (step S200). Subsequently, the first agent function determines whether the certainty factor of the response result is less than the threshold value (step S202). When it is determined that it is less than the threshold value, the first agent function outputs the speech information 162 and the speech recognition result to other agent functions (step S204) and causes the output to output response results from the other agent functions (step S206).

In the process of step S206, the first agent function may determine whether the certainty factors of the response results of the other agent functions are less than the threshold value before causing the output to output the response results of the other agent functions and cause the output to output the response results when they are not less than the threshold value. When the certainty factors of the response results of the other agent functions are less than the threshold value, the first agent function may cause the output to output information representing that no response result is acquired or cause the output to output the response result of the first agent function and the response results of the other agent functions.

When it is determined that the certainty factor of the response result is not less than the threshold value in the process of step S202, the first agent function causes the output to output the generated response result (step S208).

According to the above-described modified example, it is possible to efficiently execute processing because other agent functions are caused to perform processing only when the certainty factor of a response result is low. It is possible to output information having a high certainty factor for the occupant to the occupant.

In the above-described embodiments, some or all functions of the agent apparatus 100 may be included in the agent server 200. Some or all functions of the agent server 200 may be included in the agent apparatus 100. That is, separation of functions in the agent apparatus 100 and the agent server 200 may be appropriately changed according to components of each apparatus, the scale of the agent server 200 or the agent system 1, and the like. Separation of functions in the agent apparatus 100 and the agent server 200 may be set for each vehicle M.

According to the agent apparatus 100 according to the above-described embodiments, it is possible to provide a more appropriate response result by including the plurality of agent functions 150 each including a recognizer (the speech recognizer 220 and the natural language processor 222) that recognizes speech according to an utterance of the occupant P of the vehicle M and providing a service including a response on the basis of a speech recognition result obtained by the recognizer, and the storage controller 116 that causes the storage 160 to store the speech of the utterance of the occupant P, wherein the first agent function selected by the occupant P from the plurality of agent functions 150 outputs speech stored in the storage 160 and the speech recognition result recognized by the recognizer to other agent functions.

According to the agent apparatus 100 according to the embodiments, each agent function can execute speech recognition in accordance with each speech recognition level and recognition conditions by outputting speech (raw speech data) of the occupant P and a speech recognition result to other agent functions, and thus deterioration of reliability with respect to speech recognition can be curbed. Accordingly, even when the occupant calls a certain agent and speaks a request in a state in which the occupant has not ascertained features and functions of each agent, it is possible to provide a more appropriate response result to the occupant by causing other agents to execute processing with respect to the utterance. Even when there is a request (command) with respect to a function that cannot be realized by a called agent from the occupant, it is possible to transfer the processing to other agents and cause them to execute the processing instead.

While forms for carrying out the present invention have been described using the embodiments, the present invention is not limited to these embodiments at all, and various modifications and substitutions can be made without departing from the gist of the present invention.

What is claimed is:

1. An agent apparatus comprising:
a plurality of agent functions each including a recognizer configured to recognize speech according to an utterance of an occupant of a vehicle and configured to provide a service including a response on the basis of a speech recognition result obtained by the recognizer; and
a storage controller configured to cause a storage to store the speech of the utterance of the occupant,
wherein a first agent function selected by the occupant from the plurality of agent functions outputs speech stored in the storage and the speech recognition result recognized by the recognizer included in the first agent function to another agent function.

2. The agent apparatus according to claim 1, wherein the first agent function outputs the speech stored in the storage and the speech recognition result to another agent function at a timing at which the speech recognition result with respect to the utterance of the occupant is acquired by the recognizer.

3. The agent apparatus according to claim 1, further comprising an output controller configure to cause an output to output a response result with respect to the utterance of the occupant,
wherein, when a certainty factor of a response result acquired by the first agent function is less than a threshold value, the output controller changes the response result provided to the occupant to a response result acquired by the other agent function and causes the output to output the changed response result.

4. The agent apparatus according to claim 1, wherein the other agent function generates a response result with respect to details of a request of the occupant on the basis of a response result of the first agent function.

5. The agent apparatus according to claim 1, wherein the first agent function selects one or more other agent functions from the plurality of agent functions on the basis of the speech recognition result obtained by the recognizer and outputs the speech stored in the storage and the speech recognition result to the selected other agent functions.

6. An agent apparatus control method, using a computer, comprising:
activating a plurality of agent functions each including a recognizer configured to recognize speech according to an utterance of an occupant of a vehicle;
providing a service including a response on the basis of a speech recognition result obtained by the recognizer as functions of the activated agent functions;
causing a storage to store the speech of the utterance of the occupant; and
by a first agent function selected by the occupant from the plurality of agent functions, outputting speech stored in the storage and the speech recognition result recognized by the recognizer included in the first agent function to another agent function.

7. A computer-readable non-transitory storage medium storing a program causing a computer to:
activate a plurality of agent functions each including a recognizer configured to recognize speech according to an utterance of an occupant of a vehicle;
provide a service including a response on the basis of a speech recognition result obtained by the recognizer as functions of the activated agent functions;
cause a storage to store the speech of the utterance of the occupant; and
by a first agent function selected by the occupant from the plurality of agent functions, output speech stored in the storage and the speech recognition result recognized by the recognizer included in the first agent function to another agent function.
